(19) United States
(12) Patent Application Publication
(10) Pub. No.: US 2003/0066383 A1
(43) Pub. Date: Apr. 10, 2003

(54) Bicycle crank arm

(76) Inventor: Cheng-Xun Jiang, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/972,894

(22) Filed: Oct. 10, 2001

(51) Int. Cl. G05G 1/14

(52) U.S. Cl. 74/594.1

(57) ABSTRACT

A crank arm for bicycles include a crank body having two bases on two ends thereof and each base has a threaded hole. A plurality of extensions extend from one of the bases and each extension is connected to a connection member. A resin layer is coated on the crank body and a carbon fiber layer is coated on the resin layer. The connection members extends from the resin layer and the carbon fiber layer so that a chainwheel is connected to the connection members by rivets or bolts.

### FIELD OF THE INVENTION

The present invention relates to a bicycle crank arm that has a body with a plurality of connection members connected thereto. A resin layer is coated on the body and a carbon fiber layer is coated on the resin layer. The connection members are connected to chainwheeles.

### BACKGROUND OF THE INVENTION

A conventional bicycle crank arm is generally made of metal material such as alloy and the metal material is heavy in weight so that it cannot be satisfied for modern bicycle frames. Few crank arms are made of aluminum which is a light material, however, is expensive so that the manufacturing cost of the crank arms is high.

### SUMMARY OF THE INVENTION

In accordance with one aspect of the present invention, there is provided a bicycle crank arm which comprises a crank body and each of two ends of the crank body have a base which has a threaded hole defined therethrough. A plurality of extensions extend from one of the bases and each extension is connected to a connection member. Each of the connection members has a hole defined therethrough. A resin layer is coated on the crank body and a carbon fiber layer is coated on the resin layer. The connection members extend from the resin layer and the carbon fiber layer so that a chainwheel is connected to the connection members.

The primary object of the present invention is to provide a bicycle crank arm that is light in weight and is easily to be manufactured.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the crank arm of the present invention;

FIG. 2 is an exploded view to show the crank body and the connection members of the crank arm of the present invention;

FIG. 3 is a perspective view to show the crank body and the connection members of the crank arm of the present invention;

FIG. 4 is a cross sectional view to show the crank body is coated by a resin layer and a carbon fiber layer, and

FIG. 5 is a perspective view to show an assembly of a chainwheel and the crank arm of the present invention.

### DETAILED DESCRIPTION OF THE PREFERRED EMBODIMENT

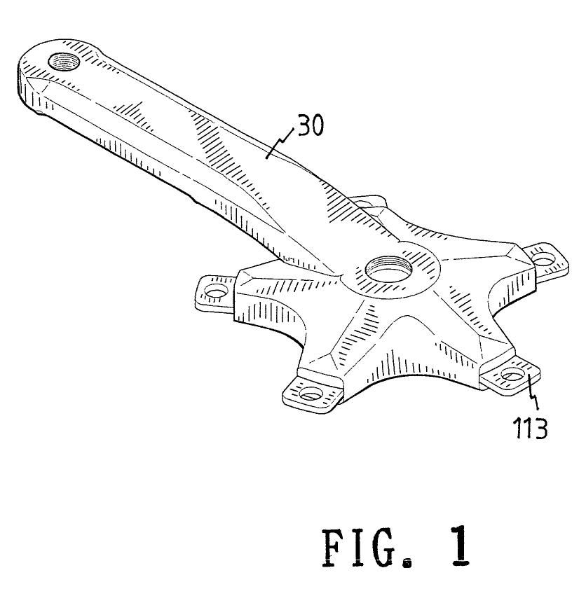

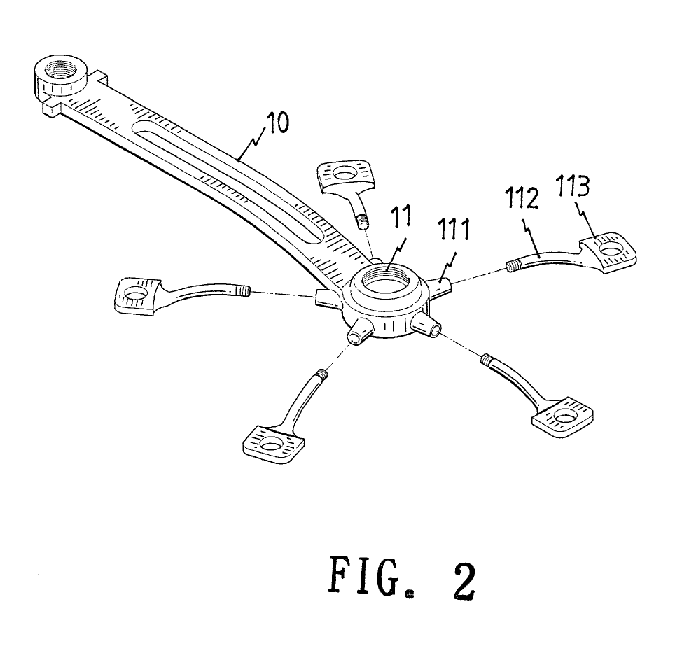

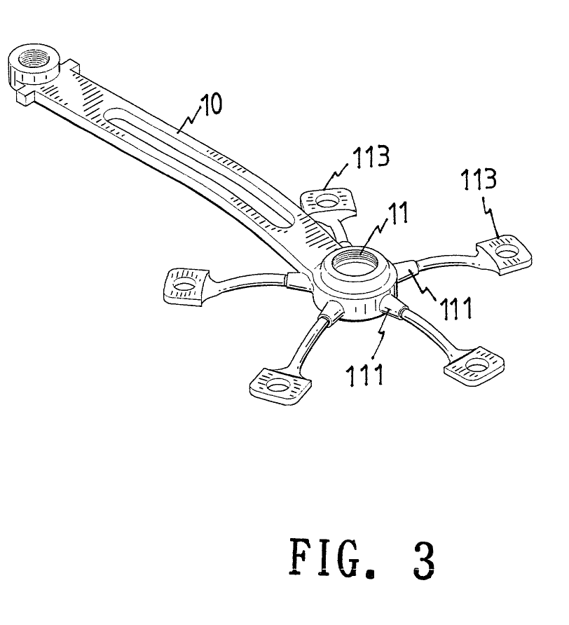

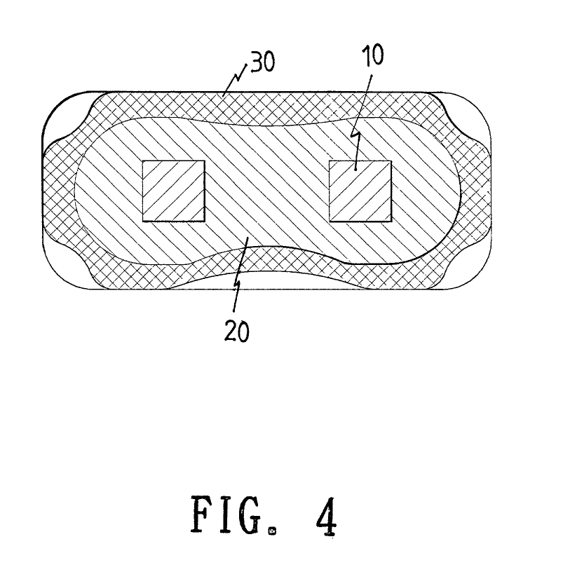

Referring to FIGS. 1 to 4, the bicycle crank arm of the present invention comprises a crank body 10 which has two bases 11 on two ends of the crank body 10 and a slot is defined through the crank body 10 so as to save material and to make the crank body 10 to be light in weight. Each of the bases 11 has a threaded hole defined therethrough for connecting a pedal and a shaft. A plurality of extensions 111 extend from one of the bases 11 and each extension 111 is connected to a connection member 113. Each of the connection members 113 has a rod 112 which is securely connected to the extension 111 and a hole is defined through each of the connection members 113.

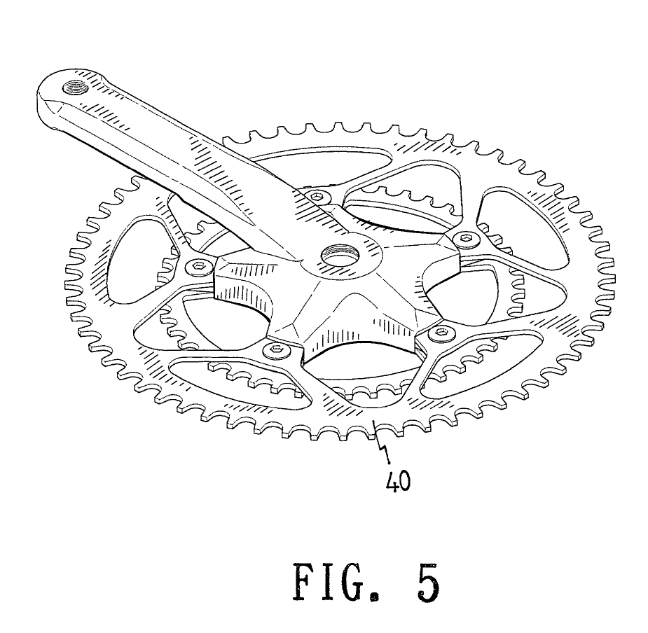

A resin layer 20 is coated on the crank body 10 and a carbon fiber layer 30 is coated on the resin layer 20. The connection members 113 extend from the resin layer 20 and the carbon fiber layer 30 so as to be connected to a chainwheel 40 by rivets or bolts as shown in FIG. 5. The crank arm is light in weight and has a strong structural strength.

While we have shown and described the embodiment in accordance with the present invention, it should be clear to those skilled in the art that further embodiments may be made without departing from the scope of the present invention.

What is claimed is:

1. A crank arm for bicycles, comprising:
a crank body and each of two ends of said crank body having a base which has a threaded hole defined therethrough, a plurality of extensions extending from one of said bases and each extension connected to a connection member, each of said connection members having a hole defined therethrough, and
a resin layer coated on said crank body and a carbon fiber layer coated on said resin layer, said connection members extending from said resin layer and said carbon fiber layer so as to be adapted to be connected to a chainwheel.
